(19) United States
(12) Patent Application Publication
(10) Pub. No.: US 2007/0165600 A1
(43) Pub. Date: Jul. 19, 2007

(54) Method for management of communications, telecommunication system for carrying out said method and associated equipment

(76) Inventors: Denis Fauconnier, Saint Remy Les Chevreuse (FR); David Choukroun, Le Chesnay (FR)

Correspondence Address: TROP PRUNER & HU, PC, 1616 S. VOSS ROAD, SUITE 750, HOUSTON, TX, 77057-2631, US

(21) Appl. No.: 10/586,901

(22) PCT Filed: Jan. 21, 2005
(86) PCT No.: PCT/FR05/00141

§ 371 Date: Jul. 21, 2006

(30) Foreign Application Priority Data
Jan. 22, 2004 (FR) 04/00609

(51) Int. Cl. H04L 12/66; H04L 12/56

(52) U.S. Cl. 370/352; 370/395.2

(57) ABSTRACT

The invention relates to terminals which can communicate through a second sub-system (3G), but not a first sub-system (2,5G) of a telecommunication system, using first and second modes of communication simultaneously. For such a terminal (1) with a current communication with the first sub-system using the first communication mode, a request for establishment of a second communication using the second communication mode for said terminal is made, said request being made by said terminal to the first sub-system, in reply to the detection of said request, a transfer of the first current communication to the second sub-system is initiated and a second communication established with the second sub-system using the second mode of communication.

The present invention relates to the management of communications in a telecommunication system. More particularly, it relates to the management of communications in an heterogeneous telecommunication system when some of the communications need to be made simultaneously.

In some recent or developing telecommunication systems, such as the so-called UMTS (Universal Mobile Telecommunication System) third generation (3G) radio communication system, communications, possibly of different types, can be set up simultaneously for one and the same terminal. In particular, a radio terminal, called UE (User Equipment), can communicate in circuit (CS) mode and in packet (PS) mode simultaneously. Thus, different services can be provided simultaneously by using the respective communication modes, such as a voice communication and a data transmission. Multiple applications derive from this, such as, for example, the facility to transmit images or digital photographs to a party with whom there is already a voice communication in progress.

In other, older telecommunication systems, on the other hand, such simultaneity of communications in possibly different modes is difficult to apply. Such is the case, for example, in the so-called GSM (Global System for Mobile communications) second generation (2G) radio communication system, or rather its extension also supporting packet mode data transmissions (2.5G), in particular GPRS (General Packet Radio Service). In practice, even though a GSM infrastructure supporting the GPRS service allows for the setting up of communications in circuit mode on the one hand, and data transmissions in packet mode on the other hand, these communication modes remain relatively segregated. Thus, only class B terminals (i.e. terminals that can support CS and PS services consecutively but not simultaneously) or class C terminals (i.e., terminals that can support PS services only) are currently developed. The class A terminals, supporting the simultaneous setting up of CS and PS communications remain too complex to be easy to produce. In particular, such terminals would require two independent receivers, so considerably increasing their cost.

A so-called DTM (Dual Transfer Mode) functionality has been developed to allow communications to be made simultaneously using different communication modes in a 2G or 2.5G network, with reduced complexity. This functionality is described in the technical specification TS 43.055, version 4.3.0, “Digital cellular telecommunications system (Phase 2+); Dual Transfer Mode (DTM); Stage 2”, published in August 2003 by the 3GPP (3rd Generation Partnership Project). When DTM is used, constraints are imposed on the radio resources involved in the two communication modes for a given mobile terminal. For example, the timeslots allocated for the CS mode and for the PS mode are always contiguous and are controlled power-wise in the same way. Such constraints thus simplify the support of simultaneous communications in different modes by simplified class A terminals, that is, terminals compatible with the DTM functionality.

However, the management of the communications remains difficult in the DTM context, inasmuch as it involves coordination between the CS and PS domains, which was not initially provided for in the GPRS system. This is why the DTM functionality is normally rarely available in practice in the deployed networks, so limiting the facility to communicate simultaneously in different communication modes in a 2G or 2.5G context.

Now, such a capability corresponds to a need, in particular when using an heterogeneous telecommunication system, one subsystem of the heterogeneous telecommunication system supporting the setting up of different mode communications simultaneously, while another subsystem of the heterogeneous telecommunication system does not support such setting up. This situation occurs in particular in the context of the deployment of UMTS systems when a GSM-GPRS network is already widely available. In such a situation, some users communicate via the 3G subsystem, while some others communicate via the 2G or 2.5G subsystem. Consequently, the services offered differ according to the users, since only those who are connected to the 3G subsystem can benefit from simultaneous CS-mode and PS-mode communications.

Such a difference can be considered to be particularly unfair for the users connected to the 2G or 2.5G subsystem, who do, however, potentially have the same dual-mode terminals as the users connected to the 3G subsystem. Furthermore, a user accustomed to making simultaneous CS-mode and PS-mode communications can be frustrated by not having the same level of service when connected to the 2G or 2.5G subsystem.

It will also be noted that the same issue can occur when communications need to be set up simultaneously in one and the same communication mode. In practice, some telecommunication systems do not support the simultaneous setting up of a number of communications of the same type, whereas others, like UMTS, do allow it. Here, too, frustration may be felt by a user who communicates via a system that allows him to have only one communication at a time, whereas this user has a multimode communication terminal that would allow him to make several simultaneous communications (for example, several independent data transmission sessions) if he were connected to such a UMTS system.

One object of the present invention is to overcome these drawbacks, by improving the chances of being able to make simultaneous communications in an heterogeneous telecommunication system.

Another object of the present invention is to improve the chances of being able to communicate simultaneously in different communication modes. Another object of the invention is to allow simultaneous communications to be set up, according to different communication modes, with reduced complexity.

The invention thus proposes a method of managing communications in a telecommunication system comprising at least one first and one second subsystem, terminals being able to communicate via the second subsystem according to both a first communication mode and a second communication mode, the terminals not being able to communicate via the first subsystem according to both the first communication mode and the second communication mode. The method comprises the following steps, in relation to one terminal having a first communication in progress with the first subsystem according to the first communication mode:
detecting a request to set up a second communication according to the second communication mode for said terminal, said set-up request being initiated by said terminal to the first subsystem;
in response to the detection of said request, initiating a transfer of the first current communication to the second subsystem; and
setting up a second communication with the second subsystem according to the second communication mode.

Two simultaneous communications in two communication modes can thus be set up simultaneously for this terminal, via the second subsystem which supports such simultaneity.

The first subsystem can, for example, be a second generation radio communication system, while the second subsystem can be a third generation radio communication system.

Regarding the communication modes, the first mode can, for example, be a circuit mode, whereas the second communication mode can be a packet mode. Other communication modes can also be used within the scope of the invention.

The detection of the set-up request can result directly from the initiation of this request by the terminal.

Advantageously, this request is sent via a message relating to the “Dual Transfer Mode” functionality described above. It can also be detected on the first subsystem. This does not, however, involve either the application or the complete support of the DTM functionality.

The transfer of the first current communication to the second subsystem is advantageously initiated, for its part, by one or other of the terminal or the first subsystem.

The invention also proposes a telecommunication system comprising a first and a second subsystem, organized to apply the above method.

The invention also proposes a terminal comprising means for communicating via a second subsystem of a telecommunication system according to both a first communication mode and a second communication mode, the terminal not being able to communicate via a first subsystem of the telecommunication system according to both the first communication mode and the second communication mode. The terminal also comprises:
means for initiating and for transmitting to the first subsystem a request to set up a second communication according to the second communication mode, when it has a first communication in progress with the first subsystem according to the first communication mode; and
means for continuing the first current communication on the second subsystem, these means being deployed after the means for initiating and for transmitting to the first subsystem a request to set up a second communication according to the second communication mode have been deployed.

The invention finally proposes an access controller in a first subsystem of a telecommunication system also comprising at least one second subsystem, terminals being able to communicate via the second subsystem according to both a first communication mode and a second communication mode, the terminals not being able to communicate via the first subsystem according to both the first communication mode and the second communication mode. The access controller comprises, in relation to one of said terminals having a first communication in progress with the first subsystem according to the first communication mode, under the control of said access controller:
means for detecting a request to set up a second communication according to the second communication mode for said terminal, said set-up request being initiated by said terminal to the first subsystem; and
means for, in response to a detection of the request to set up a second communication according to the second communication mode for said terminal, initiating a transfer of the first current communication to the second subsystem.

Other features and advantages of the present invention will become apparent from the description that follows of exemplary and non-limiting embodiments, with reference to the appended drawings, in which:

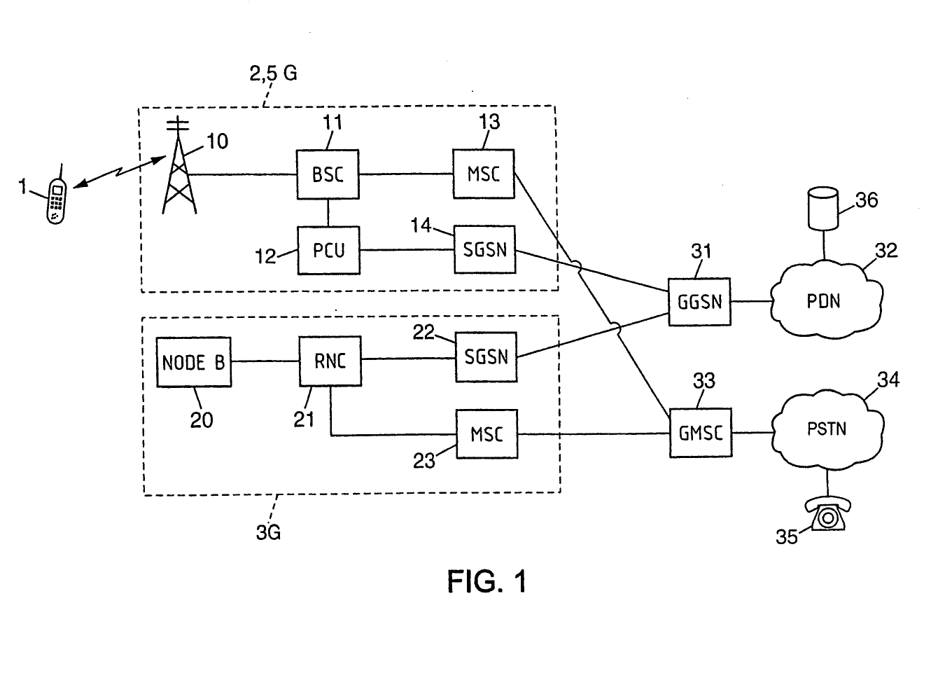

FIG. 1 is a simplified architectural diagram of an heterogeneous telecommunication system in which the invention can be implemented;

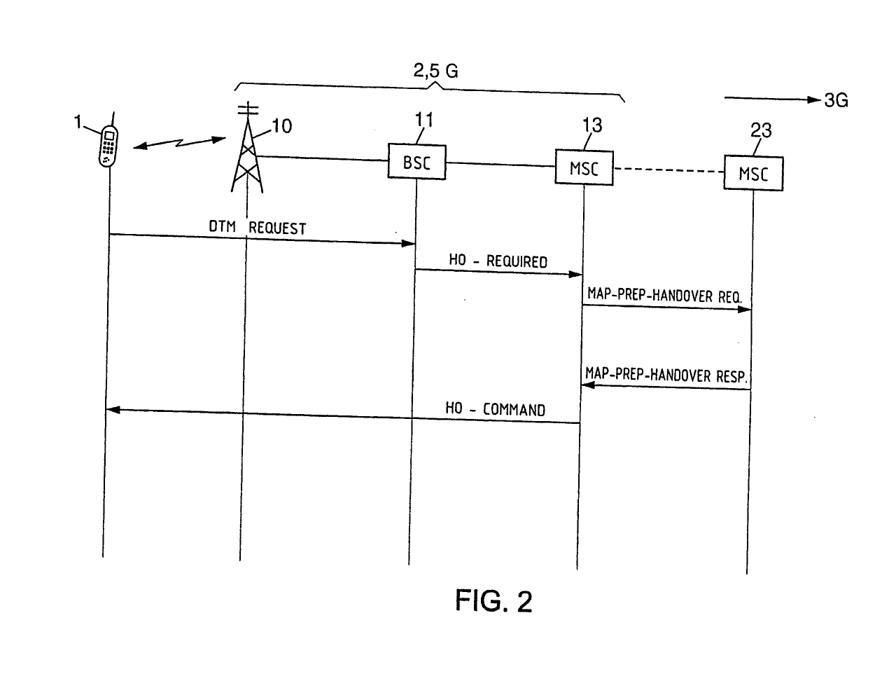

FIG. 2 is a representation of a signaling interchange in an embodiment of the invention; and

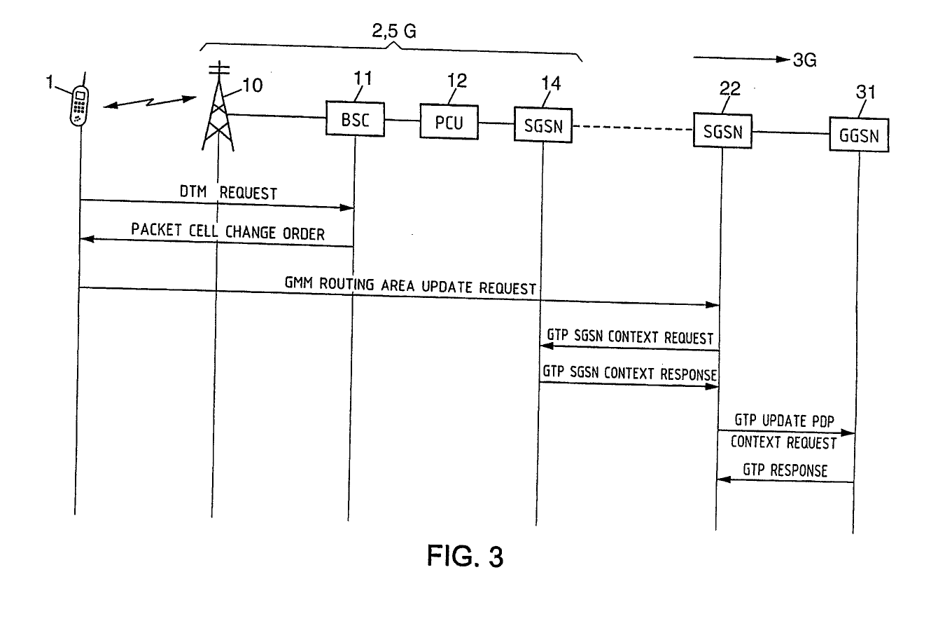

FIG. 3 is a representation of a signaling interchange in another embodiment of the invention.

FIG. 1 represents an heterogeneous telecommunication system comprising a 2.5G radio communication subsystem (which could also be 2G) and a 3G radio communication subsystem. In the description that follows, such a system is considered with only two subsystems, although the invention could equally apply to a telecommunication system with more than two subsystems.

The simplified 2.5G subsystem illustrated in FIG. 1 includes a Base Transceiver Station 10, or BTS, linked to an access controller, also called Base Station Controller 11, or BSC, which is itself connected to a core network switch 13 which is an MSC (Mobile services Switching Centre) in the case of a circuit-mode communication context. Moreover, a packet controller unit 12, or PCU, is associated with or connected to the BSC 11 and is responsible for controlling the transmissions made in packet mode via the BTS 10. The PCU 12 is also linked to a core network switch 14 responsible for packet-mode transmissions, also called SGSN (Serving GPRS Support Node).

As for the 3G subsystem, this includes a Node B 20, mainly serving as base transceiver station, linked to an access controller, also called radio network controller 21, or RNC, which is itself connected to a core network switch which can be an MSC 23, if in a circuit-mode communication context, or an SGSN 22 if in a packet-mode communication context.

The MSCs 13 and 23 of the 2.5G and 3G subsystems respectively are linked, possibly via other switches, to a GMSC (Gateway Mobile services Switching Centre) type platform 33. As for the SGSNs 14 and 22 of the 2.5G and 3G subsystems respectively, these are linked, possibly via other switches, to a GGSN (Gateway GPRS Support Node) type platform 33.

The GMSC 33 can be used to interconnect the heterogeneous telecommunication system with an external network, such as the public switched telephone network 34 (PSTN). For its part, the GGSN 31 can be used to interconnect the heterogeneous telecommunication system with an external packet data network 32, or PDN, such as the internet, for example.

A radio terminal 1, or UE (User Equipment), is capable of communicating with a remote entity, for example another terminal, via the telecommunication system illustrated in FIG. 1. Such a communication can be made either over the 2.5G subsystem or over the 3G subsystem. This UE 1 is therefore a dual-mode radio terminal (2.5G and 3G in the example described). The communication concerned is conducted according to a given communication mode, which can be CS or PS.

It is assumed below that both 2.5G and 3G subsystems have very similar radio coverages, in other words, that a UE communicating via one of the subsystems would also be able to communicate with the other subsystem, without changing position, even if the field strength received from this other subsystem were less than that received from the first subsystem.

In a first case of application of the invention, it is assumed that the UE 1 is currently communicating with the 2.5G subsystem, the communication being set up in a circuit mode. This means that the UE has a communication in progress with a remote entity (for example, a fixed terminal 35 on the PSTN 34) via the 2.5G subsystem. In this case, the communication is carried by the BTS 10 and BSC 11 radio equipment, and it is routed to the PSTN 34 via MSC 13 and GMSC 33.

As an example, it is assumed that a new PS-type communication needs to be set up for the UE 1, already engaged in a CS communication with the 2.5G subsystem. The request to set up such a communication can be transmitted to the 2.5G subsystem, on the initiative of an entity of the network or a remote entity, to set up an incoming call in PS mode (for example, a download server 36, connected to the PDN 32, tries to transmit data to the UE 1), or even on the initiative of the UE 1 itself, in order to set up an outgoing call in PS mode (for example, the UE 1 wants to transmit data to a remote terminal in PS mode).

In the case of an outgoing call, the UE therefore transmits a request to set up a communication in PS mode to the BSC 11 of the 2.5G subsystem. The transmission of the request can advantageously be based on messages already existing and available in the standardized protocol of the DTM functionality. For example, the UE 1 can transmit to the BSC 11, on a dedicated signaling channel, a “DTM Request” message, as defined in section 6.1.2.2 of the abovementioned technical specification TS 43.055. This transmission is illustrated in FIG. 2.

On receiving this “DTM Request” message, the BSC 11 triggers a procedure for transferring the current communication in CS mode from the 2.5G subsystem to the 3G subsystem. This transfer is an inter-system 2.5G→3G handover, as described in section 8.2 of technical specification TS 23.009, version 5.6.0, “Digital cellular telecommunications system (Phase 2+); Universal Mobile Telecommunications System (UMTS); Handover procedures”, published in September 2003 by the 3GPP. The main signaling messages interchanged within the framework of this handover procedure are shown in FIG. 2.

The UE 1 regularly transmits radio measurements made on its serving cell, that is, relating to signals sent by the BTS 10, and on adjacent cells, in particular relating to signals sent by the Node B 20. The BSC 11 therefore knows that the Node B 20 covers a cell on which the UE 1 would be able to continue its communication. When it receives the “DTM Request” message, the BSC 11 transmits a handover request to its parent MSC 13 (“Ho_Required” message in FIG. 2). This request possibly contains information concerning the cell covered by the Node B 20. This request is then relayed from the MSC 13 to a 3G MSC, for example the MSC 23, according to a message from the MAP (Mobile Application Part) protocol, “MAP_Prep_Handover request”. For its part, the MSC 23 alerts the RNC 21 for it to be able to set up communication resources in particular on the Node B 20. A response message “MAP_Prep_Handover response” is then transmitted to the MSC 13. The latter finally sends a command message HO_command, to indicate to the UE 1 via the BSC 11 and the BTS 10 to switch over to the resources reserved in the 3G subsystem. The UE 1 then resumes its communication in CS mode on the 3G subsystem via the Node B 20 and the RNC 21 in particular.

If the request to set up a communication in PS mode has been sent by the UE 1 to the BSC 11, the latter advantageously transmits it to the RNC 21 which controls the communications from the UE 1 after the handover procedure. Alternatively, particularly if the BSC 11 is not able to transmit to the RNC 21 the information relating to such a request, it is advantageous for the UE 1 to renew its request to set up a communication in PS mode, but this time to the RNC 21. Since simultaneous communications in CS and PS modes can be set up in UMTS, the RNC 21 then responds favorably to the set-up request from the UE 1. Then, the communication in PS mode is set up conventionally by the 3G subsystem.

Thus, the problem of the complex setting up of simultaneous communications in CS and PS mode in 2.5G technology is avoided. All that is required in this case is for the UE 1 to be able to send a request to set up a communication in PS mode, while it is currently communicating in CS mode over the 2.5G subsystem. This is all the more easily achievable if the UE 1 uses a “DTM Request” message, used in the framework of the DTM functionality. However, in the latter case, the complex DTM functionality is not, however, implemented, since the BSC 11 simply has to switch over the current communication in CS mode to the 3G subsystem, without needing to manage two simultaneous communications. The UE 1 therefore does not need to be a class A terminal, or a simplified class A terminal, in other words one fully supporting the DTM functionality, since only messages requesting the setting up of a communication in PS mode (“DTM Request”) need to be able to be transmitted by the UE 1 currently communicating in CS mode. The complexity of the UE 1 is thus considerably reduced, and therefore its cost of development and manufacture is also reduced, without impairing the services offered to the user of this UE. This user can, in practice, set up both his communications simultaneously, once he has switched over to 3G. Similarly, the 2.5G subsystem does not need to fully support the DTM functionality, since the current CS communication is transferred to the 3G subsystem before the new PS-mode communication is set up, which avoids having to put into place a complex implementation of the 2.5G subsystem.

Assuming that the call in PS mode is an incoming call, the request to set up a communication in PS mode is transmitted on the initiative of a remote entity (for example, a download server 36, connected to the PDN 32) and it is received on the 2.5G subsystem, for example on the BSC 11. On receipt of this request, the BSC 11 behaves as in the case described above. Thus, once the communication in CS mode is transferred to the 3G subsystem, the new communication in PS mode can be set up without difficulty according to the UMTS technology. The complexity associated with setting up communications in CS and PS modes simultaneously on the 2.5G subsystem is therefore avoided in this case as well.

In a second case of application of the invention, it is assumed that the UE 1 is currently communicating with the 2.5G subsystem, the communication being handled in a packet mode. This means that the UE has a communication in progress with a remote entity (for example, a server 36 of the PDN 32) via the 2.5G subsystem. In this case, the communication is conducted according to the GPRS technology, connected to the BTS 10, the BSC 11 and the PCU 12 which controls it. It is, moreover, routed to the PDN 32 via SGSN 14 and GGSN 31.

As an example, it is assumed that a new CS-type communication needs to be set up for the UE 1, already engaged in a PS-mode communication with the 2.5G subsystem. The request to set up such a communication can be transmitted to the 2.5G subsystem on the initiative of a remote entity, to set up an incoming call in PS mode (for example, a terminal 35 trying to set up a voice communication with the UE 1), or even on the initiative of the UE 1 itself, in order to set up an outgoing call in CS mode (in this case, it is the UE 1 that tries to set up a voice communication with a party).

In the case of an outgoing call, the UE 1 therefore transmits a request to set up a communication in CS mode to the BSC 11 of the 2.5G subsystem. As in the case described above, the transmission of the request can advantageously be based on messages already existing and available in the standardized protocol of the DTM functionality, for example the “DTM Request” message described above (see FIG. 3).

On receiving this “DTM Request” message, the BSC 11 triggers a procedure for transferring the current communication in PS mode from the 2.5G subsystem to the 3G subsystem. This transfer consists in interrupting the current data transmission on the 2.5G subsystem, closing the connection, also called TBF (Temporary Block Flow), which carried this transmission temporarily, then reselecting a 3G cell (in our example, the cell covered by the Node B 20), before resuming the transmission by the 3G subsystem, via the Node B 20. In this case, the cell reselection is performed on the initiative of the network.

This network-controlled operating mode is in particular provided for by the broadcasting or transmission to the UE 1 of the NC2 parameter described in section 10.1.4 of technical specification 145 008, version 5.12.0, “Digital cellular telecommunications system (Phase 2+); Radio subsystem link control”, published in August 2003 by the ETSI. The 2.5G subsystem then sends a command to the UE 1 for the latter to reselect a cell under the control of the 3G subsystem (see section 10.1.4.2 of the abovementioned technical specification 145 008). This so-called PACKET CELL CHANGE ORDER command and the inter-system cell reselection mechanism are detailed in technical specification TS 144 060, version 5.8.0, “Digital cellular telecommunications system (Phase 2+); General Packet Radio Service (GPRS); Mobile Station (MS)—Base Station System (BSS) interface; Radio Link Control/Medium Access Control (RLC/MAC) protocol”, published in September 2003.

The mobility procedure continues in the conventional way. A change of location area is in particular required by the UE 1, when the decision to reselect a 3G cell has been made (“GMM Routing Area Update Request” message in FIG. 3). Then, a signaling interchange takes place between the 3G SGSN 22 and the 2.5G SGSN 14 according to the GPRS Tunneling Protocol (GTP protocol), to indicate to the new SGSN 22 that will take over the responsibility for the transmission, the attributes of the context of this transmission, otherwise called “PDP context” (Packet Data Protocol context). This signaling interchange is illustrated in FIG. 3 by the message “GTP SGSN Context Request” and its response message “GTP SGSN Context Response”. Finally, the SGSN 22 asks the GGSN 31 to update the information that it stores concerning the PDP context relating to the transmission that is the object of the transfer (“GTP Update PDP context request” message in FIG. 3). A response is sent to the SGSN 22 by the GGSN 31, when this information is updated (“GTP Response” message in FIG. 3).

Once the PDP context has been transferred to the SGSN 22, the latter also asks the RNC 21 to allocate corresponding resources, for the transmission in PS mode to be able to be resumed between the UE 1 and the Node B 20.

As an alternative to the above description, the UE 1 can independently reselect the 3G cell covered by the Node B 20. In this case, the network does not therefore ask the UE 1 to make such a reselection, that is, the PACKET CELL CHANGE ORDER message is not transmitted to the UE 1.

Nor is it necessary, in this case, to inform the 2.5G subsystem of the request to set up a new communication in CS mode, which is tantamount to not transmitting from the UE 1 to the BSC 11, via the BTS 10, the “DTM Request” type message (the set-up request does still exist in this case, but it remains at this stage on the UE 1). In practice, since the reselection is performed by the UE 1, when the latter wants to set up an outgoing call in CS mode, without a command from the network being necessary, it is then enough for the UE 1 to reselect the cell covered by the Node B 20 as described above, then to make its request to set up a new communication in CS mode once it is connected to the 3G subsystem. The latter is then able to respond to this request, by allocating communication resources for this new communication, in particular radio resources between the UE 1 and the Node B 20.

When a request to set up a communication in CS mode has nevertheless been sent by the UE 1 to the BSC 11 (“DTM Request” message in FIG. 3), the latter can advantageously transmit it to the RNC 21 which controls the communications from the UE 1 after the procedure for transferring the current communication in PS mode. The transmission of the request is either direct if there is a communication link between the BSC 11 and the RNC 21, or via switches linking these entities.

There now follows a description of the case where it is assumed that the setting up of a communication in CS mode, while the UE 1 is already communicating in PS mode connected with the 2.5G subsystem, corresponds to an incoming call, that is, a call to the UE 1 and initiated by an entity of the 2.5G subsystem or a remote entity, such as, for example, a telephone terminal 35 connected to the PSTN 34. In this case, the BSC 11 receives the request to set up the new communication in CS mode and it responds to this request by asking the UE 1 to reselect a cell in the 3G subsystem, that is, in the example illustrated in FIG. 1, the cell covered by the Node B 20. This corresponds to the sending of the PACKET CELL CHANGE ORDER message to the UE 1, as illustrated in FIG. 3. The rest of the procedure is the same as in the previous case described and illustrated in FIG. 3. The communication in PS mode is then resumed on the cell covered by the Node B 20 of the 3G subsystem.

The request to set up a new communication in CS mode is transmitted to the RNC 21 which controls the Node B 20, or it is renewed by the entity that sent it, so as to be received and processed, this time, by the RNC 21. The latter then allocates resources for this communication in CS mode to be able to be set up, while retaining the current transmission in PS mode with the UE 1, as is supported by the UMTS technology.

In this case also, the problem of the complex setting up of simultaneous communications in CS and PS modes using the 2.5G technology has thus been avoided. It will be noted that even when the UE 1 transmits a request to set up a new communication in CS mode, in the advantageous form of the “DTM Request” message normally used in the framework of the DTM functionality, the latter is not, however, applied, since the BSC 11 does not need to manage two simultaneous communications, the current communication in PS mode with the 2.5G subsystem being transferred to the 3G subsystem before the new communication in CS mode is set up.

The present invention has been described above in the context of a telecommunication system comprising two subsystems, one of which is a 2.5G type radio communication subsystem and the other a 3G type radio communication system. However, it can also be applied to other types of telecommunication systems comprising more than two subsystems, each of these subsystems being able to set up communications with terminals according to communication modes that may differ according to the subsystems.

Thus, when more than two subsystems are used, when at least one first communication is in progress on a given subsystem when a new communication needs to be set up according to a communication mode different from the first communication, the first communication will advantageously be switched over to one of the subsystems supporting both the communication mode for the first current communication and the one required for the new communication to be set up.

Finally, it will be noted that, although the invention was more specifically described above in a case where each of the subsystems of the telecommunication system supports communication modes that are different from each other, the invention applies also when the subsystems support the same communication modes. In this case, a first communication in progress with the first subsystem according to a communication mode is switched over to the second subsystem when a second communication needs to be set up according to the same communication mode. This is tantamount to stating that the first communication mode used by the first current communication and the second communication mode of the second communication to be set up are the same. This embodiment is advantageous in particular in the case where a second subsystem of the telecommunication system supports the setting up of simultaneous communications for a given terminal, unlike a first subsystem with which the terminal is communicating and which supports the setting up of only one communication at a time for a given terminal.

1. A method of managing communications in a telecommunication system comprising at least one first and one second subsystems, terminals being able to communicate via the second subsystem according to both a first communication mode and a second communication mode, the terminals not being able to communicate via the first subsystem according to both the first communication mode and the second communication mode,
the method comprising the following steps, in relation to one of said terminals having a first communication in progress with the first subsystem according to the first communication mode:
detecting a request to set up a second communication according to the second communication mode for said terminal, said set-up request being initiated by said terminal to the first subsystem;
in response to the detection of said request, initiating a transfer of the first current communication to the second subsystem; and
setting up a second communication with the second subsystem according to the second communication mode.

2. The method as claimed in claim 1, in which the first subsystem is a second generation radio communication system.

3. The method as claimed in claim 1, in which the second subsystem is a third generation radio communication system.

4. The method as claimed in claim 1, in which the first communication mode is a circuit mode.

5. The method as claimed in claim 1, in which the second communication mode is a packet mode.

6. The method as claimed in claim 5, in which the first subsystem is a second generation radio communication system and in which the request to set up a second communication is sent by the terminal via a message relating to the “Dual Transfer Mode” functionality.

7. The method as claimed in claim 1, in which the detection of the request to set up a second communication results from the initiation of said request by the terminal.

8. The method as claimed in claim 1, in which the detection of the request to set up the second communication is carried out on the first subsystem.

9. The method as claimed in claim 1, in which the transfer of the first current communication to the second subsystem is initiated by one or other of the terminal or the first subsystem.

10. (canceled)

11. A terminal comprising:
means for communicating via a second subsystem of a telecommunication system according to both a first communication mode and a second communication mode, the terminal not being able to communicate via a first subsystem of the telecommunication system according to both the first communication mode and the second communication mode;
means for initiating and for transmitting to the first subsystem a request to set up a second communication according to the second communication mode, when it has a first communication in progress with the first subsystem according to the first communication mode; and
means for continuing the first current communication on the second subsystem, these means being deployed after the means for initiating and for transmitting to the first subsystem a request to set up a second communication according to the second communication mode have been deployed.

12. The terminal as claimed in claim 11, in which the first subsystem is a second generation radio communication system.

13. The terminal as claimed in claim 12, in which the means for initiating and transmitting to the first subsystem a request to set up a second communication according to the second communication mode use a message relating to the “Dual Transfer Mode” functionality.

14. The terminal as claimed claim 11, in which the second subsystem is a third generation radio communication system.

15. The terminal as claimed in claim 11, in which the first communication mode is a circuit mode.

16. The terminal as claimed in claim 11, in which the second communication mode is a packet mode.

17. The terminal as claimed in claim 11, in which the means for continuing the first current communication on the second subsystem respond to a command from the first subsystem.

18. The terminal as claimed in claim 11, in which the means for continuing the first current communication on the second subsystem respond to an initiation and a transmission by the means for initiating and for transmitting a request to set up a second communication according to the second communication mode.

19. An access controller in a first subsystem of a telecommunication system also comprising at least one second subsystem, terminals being able to communicate via the second subsystem according to both a first communication mode and a second communication mode, the terminals not being able to communicate via the first subsystem according to both the first communication mode and the second communication mode, and the access controller comprising, in relation to one of said terminals having a first communication in progress with the first subsystem according to the first communication mode, under the control of said access controller:
means for detecting a request to set up a second communication according to the second communication mode for said terminal, said set-up request being initiated by said terminal to the first subsystem; and
means for, in response to a detection of the request to set up a second communication according to the second communication mode for said terminal, initiating a transfer of the first current communication to the second subsystem.

20. The access controller as claimed in claim 19, in which the first subsystem is a second generation radio communication system.

21. The access controller as claimed in claim 19, in which the second subsystem is a third generation radio communication system.

22. The access controller as claimed in claim 19, in which the first communication mode is a circuit mode.

23. The access controller as claimed in claim 19, in which the second communication mode is a packet mode.

24. The access controller as claimed in claim 19, in which the means for detecting a request to set up a second communication according to the second communication mode for said terminal comprise the reception of a message relating to the “Dual Transfer Mode” functionality.

25. A telecommunication system comprising:
at least one first and one second subsystems, terminals being able to communicate via the second subsystem according to both a first communication mode and a second communication mode, the terminals not being able to communicate via the first subsystem according to both the first communication mode and the second communication mode,
the system further comprising, in relation to one of said terminals having a first communication in progress with the first subsystem according to the first communication mode:
means for detecting a request to set up a second communication according to the second communication mode for said terminal, said set-up request being initiated by said terminal to the first subsystem;
means for, in response to the detection of said request, initiating a transfer of the first current communication to the second subsystem; and
means for setting up a second communication with the second subsystem according to the second communication mode.

26. The system as claimed in claim 25, in which the first subsystem is a second generation radio communication system.

27. The system as claimed in claim 25, in which the second subsystem is a third generation radio communication system.

28. The system as claimed in claim 25, in which the first communication mode is a circuit mode.

29. The system as claimed in claim 25, in which the second communication mode is a packet mode.

30. The system as claimed in claim 29, in which the first subsystem is a second generation radio communication system and in which the request to set up a second communication is sent by the terminal via a message relating to the “Dual Transfer Mode” functionality.

31. The system as claimed in claim 25, in which the means for detecting the request to set up a second communication result from the initiation of said request by the terminal.

32. The system as claimed in claim 25, in which the means for detecting the request to set up the second communication are carried out on the first subsystem.

33. The system as claimed in claim 25, in which the means for initiating the transfer of the first current communication to the second subsystem are implemented by one or other of the terminal or the first subsystem.
